(19) United States
(12) Patent Application Publication
(10) Pub. No.: US 2025/0007406 A1
(43) Pub. Date: Jan. 2, 2025

(54) BOOST CONVERTER CIRCUITS

(71) Applicant: Nordic Semiconductor ASA, Trondheim (NO)

(72) Inventors: Bjørnar HERNES, Trondheim (NO); Ola BRUSET, Trondheim (NO)

(73) Assignee: Nordic Semiconductor ASA, Trondheim (NO)

(21) Appl. No.: 18/704,355

(22) PCT Filed: Oct. 31, 2022
(86) PCT No.: PCT/EP2022/080386

§ 371 Date: Apr. 24, 2024

(30) Foreign Application Priority Data
Nov. 2, 2021 (GB) 2115734.2

(51) Int. Cl. H02M 3/158; H02M 1/00; H02M 1/36

(52) U.S. Cl. CPC H02M 3/158; H02M 1/0022; H02M 1/0032; H02M 1/36

(57) ABSTRACT

A boost converter circuit is provided comprising an input arranged to receive an input voltage; an output arranged to generate a higher, output voltage for powering a further circuit portion; a switching arrangement arranged to control generation of the output voltage; and a control circuit portion arranged to monitor the input voltage and control the switching arrangement in response to the input voltage.

The present invention relates to boost converter circuits and related circuits.

Electronic devices are often powered using direct current (DC) power sources such as batteries. In many cases the unloaded (also referred to as nominal) voltage of the power source does not match one or more voltage requirements of the electronic device, and can also vary according to the age of the power source, its state of charge and/or ambient conditions (e.g. temperature). For instance, a particular single cell battery might generate an unloaded voltage of between 1.5 V and 1.7 V when it is fully charged, and between 0.9 V and 1.1 V when nearly fully discharged. Many electronic devices often require higher voltages to operate, such as 3 V or 5 V.

Some devices utilise a boost converter (also known as a step-up converter) to step up an input voltage (e.g. from a low-voltage battery) to a higher output voltage suitable for operating the device, whilst correspondingly stepping down an input current to a lower output current. Conservation of energy dictates that the input and output voltage and current of a boost converter are related according to:

$${I}_{out} = K ( \frac{{V}_{in}}{{V}_{out}} ) {I}_{in} , \qquad ( 1 )$$

where Iᵢₙ, Iₒᵤₜ, Vᵢₙ and Vₒᵤₜ are the input and output currents and voltages, and K is the efficiency of the boost converter.

The current demands of a device can vary over time (e.g. as the device performs different functions or enters into different power modes). Boost converters must therefore be capable of delivering different amounts of output current at different times. Typically, a boost converter is controlled to maintain a target output voltage. For instance, if the current demand of a device supplied by a boost converter increases, the output voltage will momentarily drop, which can be detected and compensated for (i.e. by the boost converter drawing a greater input current from the input power source). However, this approach may not be optimal for power sources which have relatively low current capabilities (e.g. low-capacity batteries), as simply drawing more current from these may cause the input voltage to decrease (e.g. due to a voltage drop over non-zero internal resistances), which actually causes the output current to decrease (see equation (1) above). Boost converter circuits can also suffer from slow start up times.

An improved approach may be desired.

When viewed from a first aspect the present invention provides a boost converter circuit comprising:
an input arranged to receive an input voltage;
an output arranged to generate a higher, output voltage for powering a further circuit portion;
a switching arrangement arranged to control generation of the output voltage; and
a control circuit portion arranged to monitor the input voltage and control the switching arrangement in response to the input voltage.

In accordance with the invention, operation of a boost converter circuit may be made more reliable and optimal by controlling its switching arrangement in response to an input voltage. For instance, if the boost converter circuit has a low capacity battery as a power source, the input voltage may vary significantly from an unloaded value depending on the current drawn and internal resistances. Controlling the boost converter circuit based on the input voltage allows for such changes to be monitored and accounted for. This may, for instance, allow the boost converter circuit to produce a higher output current than is currently reliably achievable.

In some embodiments, the control circuit portion is arranged to compare the input voltage with a reference input voltage and control the switching arrangement in response to the outcome of this comparison. For instance, the control circuit portion may control the switching arrangement to ensure that the input voltage does not fall below the reference input voltage. The boost converter circuit may comprise a comparator arranged to compare the input voltage with a reference input voltage.

As explained above, the input and output voltages and currents of a boost converter circuit are related according to equation (1). The voltage Vᵢₙ and current Iᵢₙ supplied by a power source, its unloaded operating voltage Vₙₒₘ and its internal resistance Rᵢₙₜ are related according to:

$${V}_{in} = {V}_{unl} - {I}_{in} {R}_{int} , \qquad ( 2 )$$

$$∴ {I}_{in} = \frac{{V}_{unl} - {V}_{in}}{{R}_{int}} . \qquad ( 3 )$$

Combining equations (1) and (3) means that the output current of the boost converter, Iₒᵤₜ, can be expressed as:

$$\begin{matrix}{I}_{out} & = & K ( \frac{{V}_{in}}{{V}_{out}} ) ( \frac{{V}_{unl} - {V}_{in}}{{R}_{int}} ) & ( 4 ) \\ & = & ( \frac{K}{{V}_{out} {R}_{int}} ) ( {V}_{unl} {V}_{in} - {V}_{in}^{2} ) . & ( 5 ) \\ & & & \end{matrix}$$

It can be seen therefore that for a constant output voltage Vₒᵤₜ, unloaded voltage Vₙₒₘ and internal resistance Rᵢₙₜ, the output current Iₒᵤₜ is a non-linear function of the input voltage Vᵢₙ. Therefore, controlling the boost converter circuit according to the input voltage allows for more optimal control over the output current than conventional approaches based solely on monitoring the output voltage. For instance, it may be possible to more easily and reliably maximise the current output by the boost converter.

In some sets of embodiments the control circuit portion is arranged to control the switching arrangement to limit an output current of the boost converter circuit in response to the input voltage. For example, the control circuit portion may be arranged to control the switching arrangement so as to limit the output current of the boost converter circuit when the input voltage indicates that the output current is near or at a maximum value. This may be achieved by comparing the input voltage with a reference input voltage and controlling the switching arrangement to limit the output current of the boost converter circuit in response to the outcome of this comparison.

The maximum of equation (5) is found when V_{in,max}=Vᵤₙₗ/2. In other words, the theoretical maximum output current of the boost converter occurs when the input voltage drops to half of its unloaded value. In some embodiments, the reference input voltage is derived from this unloaded power supply voltage, e.g. equalling half or approximately half of the unloaded power supply voltage. Although the theoretical maximum output current of the boost converter occurs when the input voltage drops to half of its unloaded value, good performance may be obtained over a range of reference input voltages. In some embodiments, the reference input voltage is between 25% and 75% of an unloaded power supply voltage, between 35% and 65% of an unloaded power supply voltage or between 45% and 55% of an unloaded power supply voltage.

In other words the control circuit portion may be arranged to control the switching arrangement to limit the output current of the boost converter circuit based on a comparison between the input voltage and a reference input voltage derived from this unloaded power supply voltage. The control circuit portion may be arranged to control the switching arrangement to limit the output current of the boost converter circuit when the input voltage equals (or is within a predetermined range of) half the unloaded power supply voltage. In other words, the control circuit portion may prevent the boost converter circuit from attempting to deliver a higher current when the input voltage has dropped to a value indicating that the output current is at its maximum possible level.

It will be understood that the unloaded power supply voltage refers to the voltage output by the power supply when it is not subject to any load. The unloaded power supply voltage can also vary over time depending for instance on the age of the power source, its state of charge and/or ambient conditions such as temperature. Thus, whilst the unloaded power supply voltage may (in at least some circumstances) be the theoretical ideal comparison for maximising current output, in practice this unloaded voltage may not be known to the control circuit portion. For instance, a boost converter circuit may be designed to operate with several different power sources with different unloaded voltages, and the unloaded voltages of power supplies can themselves vary according to local ambient conditions, their state of charge, their age and/or other operational parameters. In some embodiments the boost converter circuit may be arranged to estimate and/or directly measure an unloaded power supply voltage, although the additional circuitry required for this may be prohibitive.

Thus, in some embodiments, additionally or alternatively, the reference input voltage is a predetermined reference input voltage. In other words, the control circuit portion may be arranged to control the switching arrangement to limit the output current of the boost converter circuit based on a comparison between the input voltage and a predetermined reference input voltage. The control circuit portion may be arranged to control the switching arrangement to limit the output current of the boost converter circuit when the input voltage reaches (or is within a predetermined range of) the predetermined reference input voltage. Whilst the use of a fixed, predetermined reference input voltage may not always be strictly optimal, the applicant has recognised that it can provide good performance for a wide range of power supply voltages whilst being simpler to implement than actively measuring an unloaded power supply voltage. Furthermore, the predetermined reference input voltage may be determined based at least partially on minimum and/or maximum voltage requirements of other circuitry connected to the power source.

The predetermined reference input voltage may be derived from an unloaded power supply voltage or an estimate of an unloaded power supply voltage. The predetermined reference input voltage may be between 25% and 75% of an unloaded power supply voltage, between 35% and 65% of an unloaded power supply voltage, between 45% and 55% of an unloaded power supply voltage or approximately half of an unloaded power supply voltage. The predetermined reference input voltage be derived from an average of unloaded voltages of a plurality of possible power sources. The predetermined reference input voltage may be derived from an unloaded voltage of a possible power source (or an average unloaded voltage of a plurality of power sources) having an average age and/or when operated in average ambient conditions. Similarly, the predetermined reference input voltage may be derived from an unloaded voltage of a possible power source (or an average unloaded voltage of a plurality of power sources) having a particular age and/or when operated in particular ambient conditions (e.g. those expected for the implementation of the boost converter circuit).

In a set of embodiments, the predetermined reference input voltage is between 0.1 V and 2 V. For instance, the predetermined reference input voltage is approximately 0.55 V, 0.75 V or 0.9 V. These reference input voltages may be particularly suitable for a power supply with an unloaded voltage between 1 V and 2 V.

The first aspect of the invention extends to a circuit portion comprising:
a power source arranged to generate the input voltage; and
the boost converter circuit as disclosed herein, wherein the input is connected to the power source such that the boost converter circuit receives the input voltage from the power source.

In a set of embodiments, the circuit portion further comprises a decoupling capacitor, wherein the circuit portion is configured to operate in:
a first mode in which the decoupling capacitor is connected to the power source; and
a second mode in which the decoupling capacitor is connected to the output of the boost converter circuit so as to provide decoupling to the further circuit portion.

This provides a more flexible approach to decoupling capacitor charging by selectively connecting the decoupling capacitor to the power source or the output of the boost converter circuit. For instance, the circuit portion may be arranged to operate in the first mode prior to operating in the second mode (e.g. immediately prior), and the decoupling capacitor can be charged to the input voltage generated by the power source in the first mode, and then simply topped up to the output voltage generated by the boost converter circuit in the subsequent period of second mode operation. This may allow charging times to be reduced. It will be recognised that this may be particularly beneficial in scenarios in which the output current of the boost converter circuit is restricted, as it may take a long time to fully charge the decoupling capacitor using the boost converter circuit with this limited current.

In a set of embodiments, the second mode is an operational mode. In the operational mode the boost converter circuit may be arranged to generate the output voltage for powering a load (e.g. a System-on-Chip) connected to the circuit portion. In the operational mode the decoupling capacitor is charged to the output voltage to provide effective decoupling to the output. By connecting the decoupling capacitor to the power source in an earlier first mode, the decoupling capacitor is already part-way charged towards the output voltage when a period of operation begins, reducing the time it takes for the decoupling capacitor to reach the output voltage compared to conventional arrangements in which decoupling capacitors are entirely discharged in non-operational modes.

In some embodiments, the first mode is a sleep mode (e.g. a lowest power mode or a “ship-mode”). In the sleep mode the boost converter circuit may be inactive such that a load connected to the circuit portion is un-powered. In a sleep mode the output of the boost converter circuit may be 0 V. The first mode may, additionally or alternatively, comprise a start-up (e.g. mode between a sleep mode and an operational mode). In some such embodiments the decoupling capacitor may be entirely discharged during sleep (e.g. to avoid leakage currents) and then be charged to the input voltage generated by the power source during a start-up period before the boost converter circuit is fully operational, reducing the amount of charge that must be provided through the boost converter circuit in the second (e.g. operational) mode. In some embodiments, the start-up mode may be considered as a type of sleep mode.

In a set of embodiments, additionally or alternatively, the circuit portion comprises:
a first decoupling capacitor; and
a second decoupling capacitor;
wherein the circuit portion is configured to operate in:
a start-up mode in which the first decoupling capacitor is connected to the output of the boost converter circuit so as to provide decoupling to the further circuit portion, and in which the second decoupling capacitor is charged towards the output voltage with a limited charging current; and
an operational mode in which the first and second decoupling capacitors are connected to the output of the boost converter circuit so as to provide decoupling to the further circuit portion.

In such embodiments the start-up time of the circuit portion may be reduced. By splitting the full decoupling capabilities of the circuit portion into the first and second decoupling capacitors, the circuit portion can power and provide decoupling to the further circuit portion without having to wait for the entire decoupling capacitance to be ready. Limiting the current with which the second decoupling capacitor is charged allows the boost converter circuit to power the further circuit portion and charge the second decoupling capacitor at the same time. Whilst full (e.g. high-current) operation of the further circuit portion in the operational mode may require the combined decoupling capacity of the first and second decoupling capacitors, the applicant has recognised that in many situations the decoupling provided by the first decoupling capacitor may be sufficient for some operations of many further circuit portions (e.g. initial start-up operations). In the operational mode the first and second decoupling capacitors may effectively act together as a single larger decoupling capacitor.

In some sets of embodiments the second decoupling capacitor has a larger capacitance than the first decoupling capacitor. The smaller first decoupling capacitor may thus be quickly charged by simply connecting it to the output of the boost converter circuit, whilst the larger second decoupling capacitor is trickle charged with the limited charging current. In some embodiments the second decoupling capacitor has a capacitance of at least two times that of the first decoupling capacitor, at least five times that of the first decoupling capacitor, at least twenty times that of the first decoupling capacitor or even at least 50 or 100 times that of the first decoupling capacitor.

In some sets of embodiments the circuit portion comprises a current-limiter (e.g. a current limiting resistor) to limit the charging current with which the second decoupling capacitor is charged in the start-up mode. For instance, the second decoupling capacitor may be connected to the output of the boost converter circuit in series with a current-limiting resistor in the start-up mode.

In some embodiments, in the operational mode a charging current of the second decoupling capacitor is not limited. For instance in embodiments featuring a current-limiting resistor, the current-limiting resistor may be shorted in the operational mode to ensure it does not hinder decoupling.

The current-limiting resistor may have a resistance selected such that the charging current does not exceed a predetermined threshold, e.g. based on an assumed maximum current deliverable by the boost converter circuit. The resistance of the current-limiting resistor may be selected for optimisation with a particular power source and/or boost converter circuit and/or for a particular set of operating voltages. The current-limiting resistor may comprise a fixed resistance (e.g. a particular resistor selected for one implementation), but in some sets of embodiments the current-limiting resistor comprises a variable resistor (e.g. a programmable resistor) whose resistance may be changed to suit different implementations.

The use of a current-limiting resistor to limit the charging current may be relatively simple to implement and allows a level of implementation-specific optimisation. However, further optimisations may be possible. For instance, when a current limiting resistor is used to limit the current, the magnitude of the charging current decreases as the second decoupling capacitor approaches the output voltage. This means that the maximum current permitted by the current-limiting resistor is thus only actually utilised right at the start of the charging cycle and that the rest of the charging process effectively uses an unnecessarily low charging current. Furthermore, the variability of operational conditions and voltages means that the resistance of the current-limiting resistor must be selected conservatively and may not actually allow the maximum current flow possible at all.

Therefore, in some sets of embodiments, additionally or alternatively, the circuit portion comprises a pulse charging circuit portion arranged to monitor the output voltage and to charge the second decoupling capacitor in the start-up mode response to the output voltage. The output voltage level drops when the current drawn from the boost converter circuit is above its maximum current capability, and thus monitoring the output voltage allows the pulse charging circuit portion to determine when there is surplus current capability and to use this to charge the second decoupling capacitor. Because this approach actively monitors the current delivery capacity of the boost converter circuit, the current limit is automatically adapted, allowing the second decoupling capacitor to be charged more quickly than an approach based on selecting a specific current-limiter (e.g. a current limiting resistor) based on an estimate of the current delivery capacity. If the maximum current output of the boost converter circuit is relatively low, the pulses will automatically be spaced out more in time, i.e. putting a relatively lower limit on the charging current. Conversely if the maximum current output of the boost converter circuit is relatively high, the pulses will be closer together, putting a relatively higher limit on the charging current.

Furthermore, whilst the overall charging current to the second decoupling capacitor is limited by the pulses in which it is active, there may be no current-limiter limiting the current flowing in each charging pulse. This means that the charging rate during the charging pulses remains relatively high even as the second decoupling capacitor approaches the output voltage.

The pulse charging circuit portion may be arranged to compare the output voltage to a reference output voltage and to charge the second decoupling capacitor based on the output of this comparison. For instance, the pulse charging circuit portion may be arranged to charge the second decoupling capacitor when the output voltage is above the reference output voltage. The reference output voltage may be selected based on a target output voltage for powering the further circuit portion (e.g. an optimal operating voltage for the further circuit portion). For instance, the reference output voltage may be equal to a target output voltage. The reference output voltage may be programmable, e.g. to match requirements of a particular further circuit portion. The circuit portion may comprise a comparator arranged to compare the output voltage with the reference output voltage. The pulse charging circuit portion may share one or more components (e.g. the comparator) with a control circuit portion of the boost converter circuit.

The pulse charging circuit portion may be arranged to charge the second decoupling capacitor by selectively connecting the second decoupling capacitor to the output of the boost converter circuit, optionally via a current-limiter such as a current limiting resistance to further restrict the charging current.

These approaches to decoupling capacitor charging are considered to be independently inventive.

Thus, when viewed from a second aspect the present invention provides a circuit portion comprising:
a power source arranged to generate an input voltage;
a boost converter circuit comprising an input arranged to receive the input voltage and an output arranged to generate a higher output voltage for powering a further circuit portion; and
a decoupling capacitor;
wherein the circuit portion is configured to operate in:
a first mode in which the decoupling capacitor is connected to the power source; and
a second mode in which the decoupling capacitor is connected to the output of the boost converter circuit so as to provide decoupling to the further circuit portion.

When viewed from a third aspect the present invention provides a circuit portion comprising:
a boost converter circuit comprising an input arranged to receive an input voltage and an output arranged to generate a higher, output voltage for powering a further circuit portion;
a first decoupling capacitor; and
a second decoupling capacitor;
wherein the circuit portion is configured to operate in:
a start-up mode in which the first decoupling capacitor is connected to the output of the boost converter circuit so as to provide decoupling to the further circuit portion, and in which the second decoupling capacitor is charged towards the output voltage with a limited charging current; and
an operational mode in which the first and second decoupling capacitors are connected to the output of the boost converter circuit so as to provide decoupling to the further circuit portion.

Features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the first, second and third aspects may also apply to the other aspects of the invention.

For instance, circuit portions according to the second and/or third aspects may utilise a boost converter circuit according the first aspect. Additionally or alternatively, a circuit portion according to the third aspect may include features of the second aspect and vice-versa. For instance, a circuit portion according to the third aspect may comprise a power source arranged to generate the input voltage. In such a circuit portion the first and/or second decoupling capacitor may be arranged to be connected to the power source when the circuit portion is in a first mode, and to be connected to the output of the boost converter circuit when the circuit portion is in a second mode. The start-up mode may form part of the first mode or the second mode or may be an entirely separate mode (e.g. a start-up mode between a sleep mode and an operational mode).

When viewed from yet another aspect the invention provides a circuit portion
a power source arranged to generate an input voltage;

a boost converter circuit comprising an input arranged to receive the input voltage and an output arranged to generate a higher, output voltage for powering a further circuit portion; and
a first decoupling capacitor; and
a second decoupling capacitor;
wherein the circuit portion is configured to operate in:
a first mode in which the first and/or second decoupling capacitor is connected to the power source;
a start-up mode in which the first decoupling capacitor is connected to the output of the boost converter circuit so as to provide decoupling to the further circuit portion, and in which the second decoupling capacitor is charged towards the output voltage with a limited charging current; and
an operational mode in which the first and second decoupling capacitors are connected to the output of the boost converter circuit so as to provide decoupling to the further circuit portion.

In some embodiments, the first mode is the start-up mode.

When viewed from yet another aspect the invention provides a circuit portion comprising:
a boost converter circuit comprising:
   an input arranged to receive an input voltage;
   an output arranged to generate a higher, output voltage for powering a further circuit portion;
   a switching arrangement arranged to control generation of the output voltage; and
   a control circuit portion arranged to monitor the input voltage and control the switching arrangement in response to the input voltage;
a first decoupling capacitor; and
a second decoupling capacitor;
wherein the circuit portion is configured to operate in:
a first mode in which the first and/or second decoupling capacitor is connected to the power source;
a start-up mode in which the first decoupling capacitor is connected to the output of the boost converter circuit so as to provide decoupling to the further circuit portion, and in which the second decoupling capacitor is charged towards the output voltage with a limited charging current; and
an operational mode in which the first and second decoupling capacitors are connected to the output of the boost converter circuit so as to provide decoupling to the further circuit portion.

In some embodiments, the first mode is the start-up mode.

Further, there are several optional features of the present invention applicable to any and all of the previously described aspects.

For instance, in embodiments of any of the preceding aspects, the power source may comprise a battery. The battery may comprise a low capacity battery, e.g. a single cell battery, with a capacity of 100 mAh or less, 50 mAh or less, 20 mAh or less or 10 mAh or less. The power source may comprise an unloaded voltage of between 0.5 V and 5 V, e.g., of at least 0.7 V, 0.9 V or 1.1 V and/or of less than 4 V, 3 V, 2V or 1.7 V. The power source may comprise a non-zero internal resistance, e.g. of 1Ω or more, 5Ω or more, 10Ω or more or 20Ω or more.

The further circuit portion may comprise any circuit portion suitable for being powered by a boost converter circuit. The further circuit portion may form part of the same physical chip as the circuit portion and/or boost converter circuit and in some embodiments may be considered part of the circuit portion and/or boost converter circuit. In other embodiments the further circuit portion may comprise an external component or device. In embodiments of any of the preceding aspects, the further circuit portion may comprise a System-on-Chip (SoC). In other words, the circuit portion and/or boost converter circuit may be suitable for powering a SoC. The circuit portion and/or boost converter circuit may be arranged to power a SoC.

A target output voltage for the boost converter circuit may be between 1 V and 10 V, e.g. between 1.6 V and 3.6 V. In some embodiments, the reference output voltage may be programmable, e.g. to match a target output voltage of the boost converter circuit. For instance, the reference output voltage may be programmable between 1 V and 10 V, e.g. in 100 mV increments. This may allow the circuit portion to be used with a variety of further circuit portions.

In embodiments of any of the preceding aspects, additionally or alternatively, the circuit portion may comprise a mode control circuit portion configured to control a mode in which the circuit portion operates. For instance, the mode control circuit portion may be configured to control the circuit portion to enter an operational mode and/or a sleep mode. Controlling the circuit portion to enter an operational mode may comprise issuing an enable command to the boost converter circuit.

Conversely, controlling the circuit portion to enter a sleep mode may comprise issuing a disable command to the boost converter circuit. In such embodiments the mode control circuit portion may comprise a hibernator circuit portion. The mode control circuit portion may operate in response to external commands (e.g. wake and/or sleep commands).

One or more non-limiting examples will now be described, by way of example only, and with reference to the accompanying figures in which:

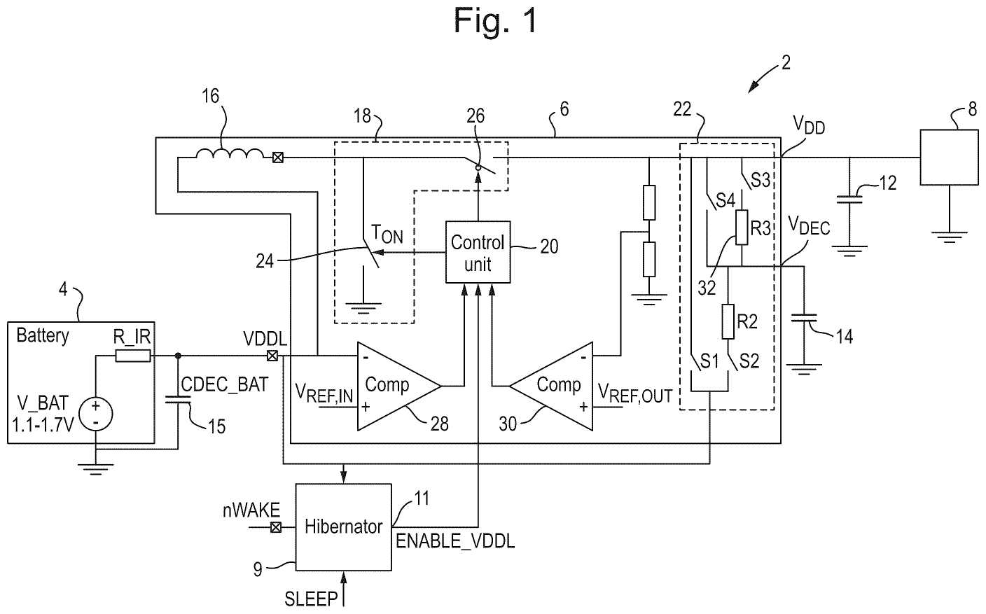

FIG. 1 is a schematic diagram of a circuit portion according to an embodiment of the invention;

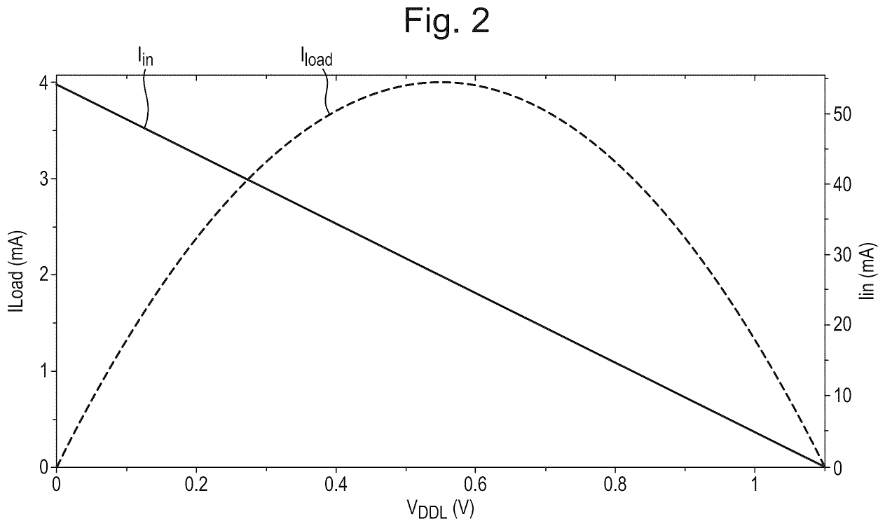

FIG. 2 is a graph illustrating the relationship between the input and output voltages and currents of a boost converter circuit;

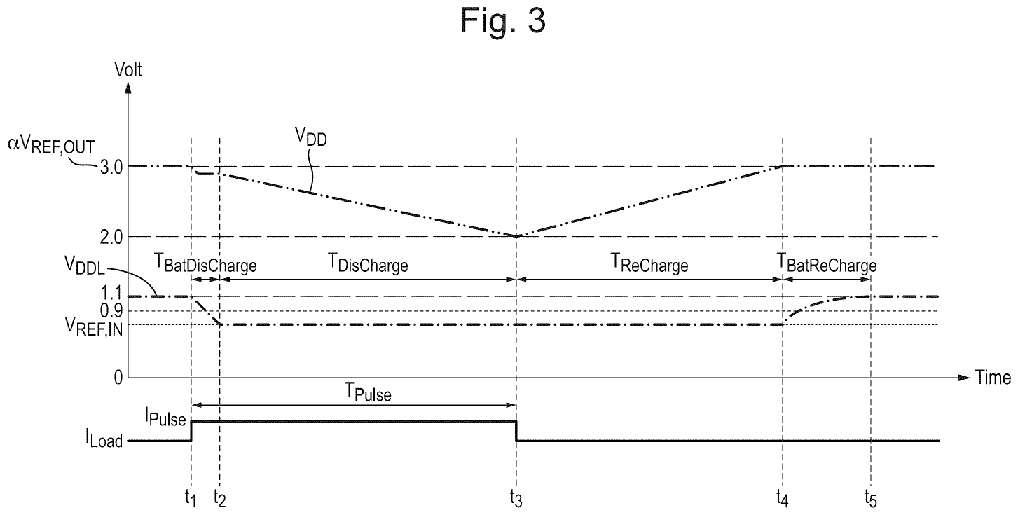

FIG. 3 is a timing diagram illustrating normal operation of the circuit portion shown in FIG. 1;

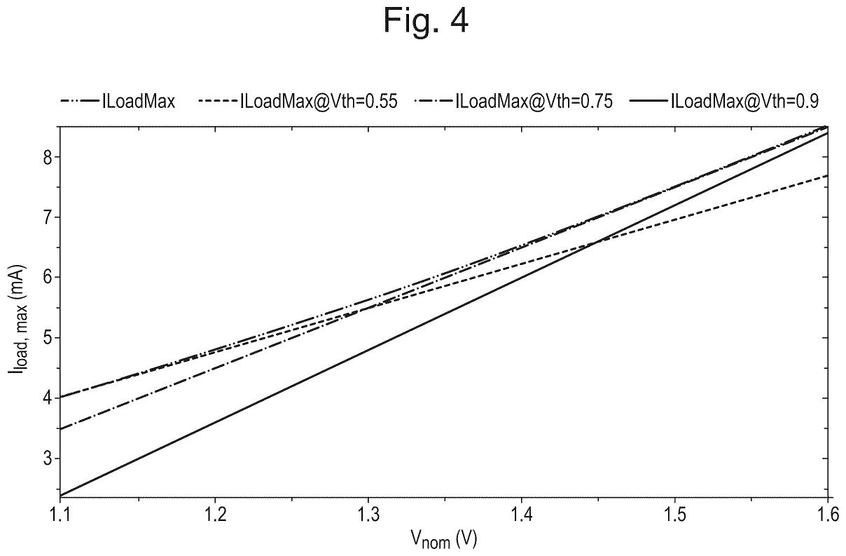

FIG. 4 is a graph illustrating maximum output currents of a boost converter circuit;

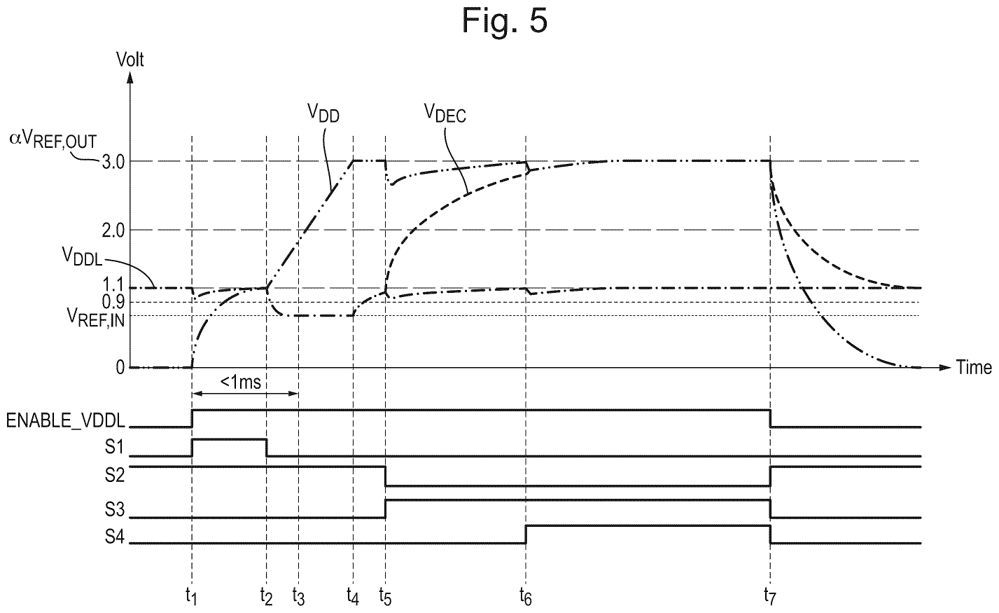

FIG. 5 is a timing diagram illustrating start-up operation of the circuit portion shown in FIG. 1;

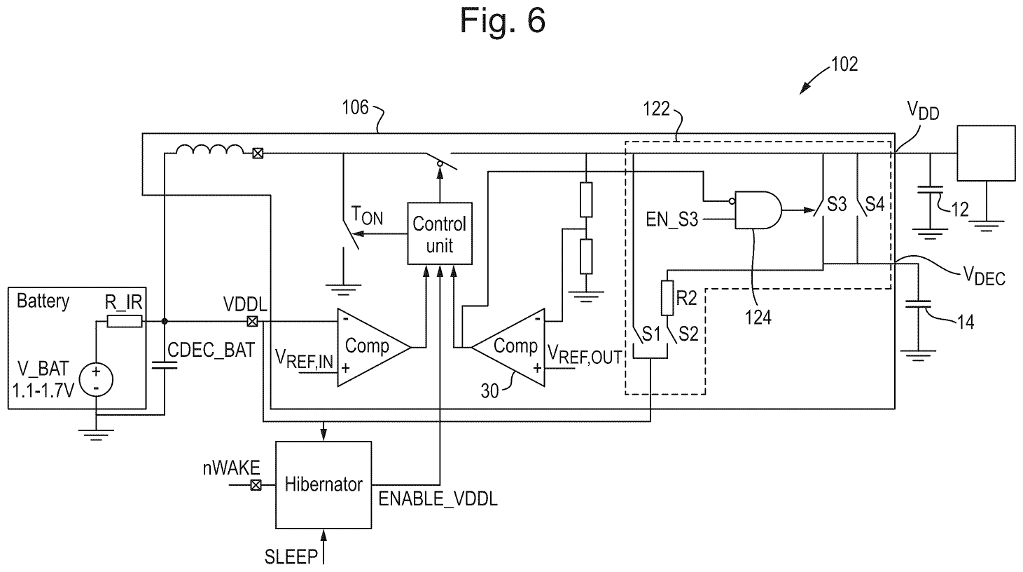

FIG. 6 is a schematic diagram of a circuit portion according to another embodiment of the invention; and

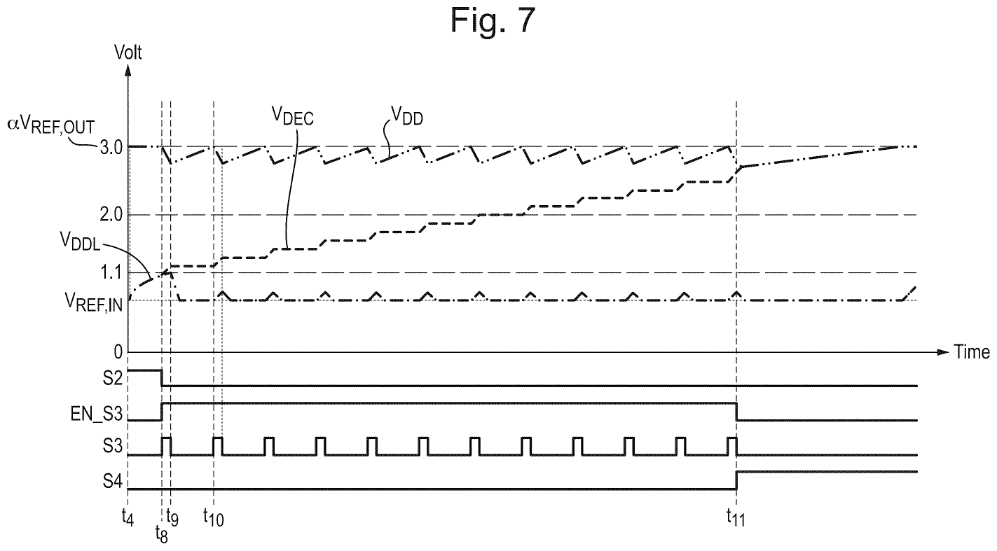

FIG. 7 is a timing diagram illustrating pulse charging operation of the circuit portion shown in FIG. 6.

FIG. 1 shows a circuit portion 2 comprising a battery 4, boost converter circuit 6 and a hibernator circuit 9. The circuit portion 2 powers a System-on-Chip (SoC) 8. As will be explained in more detail below, the boost converter circuit 6 receives an input voltage V_{DDL} from the battery 4 and provides a higher output voltage V_{DD} to the SoC 8.

The SoC 8 requires for example a voltage of between 1.8 and 3.6 V to operate. The battery 4 has a non-zero internal resistance. The battery 4 has an unloaded voltage Vᵤₙₗ of, e.g., between 1.1 V and 1.7 V, depending on, for instance, the state of charge of the battery 4 and the ambient operating conditions. The internal resistance is, e.g., roughly 20Ω.

The SoC 8 is connected to the output voltage V_{DD} in parallel with a first decoupling capacitor 12 and a second decoupling capacitor 14. The second decoupling capacitor 14 has a larger capacitance than the first decoupling capacitor. During normal operation, the decoupling capacitors 12, 14 “decouple” the SoC 8 from any noise in the power supplied by the boost converter circuit 6, and also provide a charge reservoir for satisfying transient higher current demands from the SoC 8. Similarly, the boost converter circuit 6 itself is connected to the battery 4 in parallel with a battery decoupling capacitor 15. The battery decoupling capacitor 15 also acts to smooth noise and as a charge reservoir for the boost converter circuit 6.

The boost converter circuit 6 comprises an inductor 16 connected to the input voltage V_{DDL}, a switching arrangement 18, a control circuit portion 20 and a decoupling capacitor charging portion 22. As explained in more detail below, the decoupling capacitor charging portion 22 comprises a series of switches and resistors which control how the first and second decoupling capacitors 12, 14 are charged.

The control circuit portion 20 controls operation of the switching arrangement 18. The switching arrangement 18 comprises a first switch 24 operable to connect the inductor 16 to ground and a second switch 26 operable to connect the inductor 16 to the output of the boost converter 6.

The control circuit portion 20 receives inputs from a first comparator 28, a second comparator 30 and the hibernator circuit 9. The first comparator 28 compares the input voltage V_{DDL} with a reference input voltage V_{REF,IN} as inputs. The second comparator 30 compares a divided version of the output voltage V_{DD}/α (with a determined by a pair of voltage divider resistors), with a reference output voltage V_{REF,OUT}. The reference output voltage V_{REF,OUT} is selected such that αV_{REF,OUT} equals a target output voltage V_{DD}. In this case, the target voltage is 3 V. The reference output voltage V_{REF,OUT} may be programmable, to correspond with different target voltages, e.g. for powering different SoCs.

The circuit portion 2 is operable in a sleep mode, an operational mode and a start-up mode for transitioning between the sleep mode and the operational mode. In the sleep mode, the SoC 8 and the boost converter 6 are switched off. In the operational mode the SoC 8 is active and powered by the boost converter circuit 6. The hibernator circuit 9 controls the mode of the circuit portion 2 in response to wake and sleep signals. For the sleep mode, the hibernator 9 outputs a low signal from an ENABLE output 11, and for the operational mode the hibernator 9 outputs a high signal from the ENABLE output 11.

In normal operation (i.e. in the operational mode), the boost converter circuit 6 acts as a typical boost converter, boosting the first voltage V_{DDL} from the battery 4 to the output voltage V_{DD} by switching the first and second switches 24, 26 on and off repeatedly. Each cycle of boost converter operation involves the following steps:
1. The first switch 24 closes (with the second switch 26 open) and connects the right end of the inductor 16 to ground (0 V). The current through the inductor 16 ramps up with time, as does the magnetic field generated by the inductor 16. The length of time for which the first switch 24 is closed (and the resulting current set up in the inductor 16) is controlled by the control unit 20 based on the output current requirement of the boost converter circuit 6.
2. The first switch 24 opens and the second switch 26 closes. Now, the right end of the inductor 16 is connected to the output of the boost converter circuit 6. The magnetic field in the inductor 16 will force the current to continue to flow in the same direction as before, to the output of the boost converter circuit 6. A voltage (e.m.f.) is set up over the inductor 16 in series with the input voltage V_{DDL}, to produce a higher output voltage V_{DD}.
3. When the current through the inductor 16 goes to zero, the second switch 26 opens. Both switches 24, 26 now remain open until the beginning of the next boost cycle. Alternatively, in a different mode of boost, the switches 24, 26 remain open until the output voltage V_{DD} falls below the reference output voltage V_{REF,OUT}.

In other words, in boost converter operation the switches 24, 26 are controlled to repeatedly store energy in the magnetic field of the inductor 16 and then release this to produce the boosted output voltage V_{DD}. This process maintains the output voltage V_{DD} at the predetermined target voltage at the output of the boost converter circuit 6.

The current demanded by the SoC 8 may vary depending on what actions the System-on-Chip is performing. For instance, power hungry operations such as programming, transmitting and receiving may demand relatively large currents while other operations require very little current. At times of high current demand it is important that the boost converter circuit 6 delivers the maximum possible current. As explained above with reference to equations (1) to (4) and illustrated in FIG. 2, the output current I_{load} of the boost converter circuit 6 depends on the input and output voltages V_{DDL}, V_{DD} and on the input current Iᵢₙ delivered by the battery 4. FIG. 2 shows the input and output currents Iᵢₙ, I_{load} as a function of the input voltage V_{DDL} for an unloaded battery voltage Vᵤₙₗ of 1.1 V. The unloaded voltage is that measured over the battery 4 when no current is drawn. The unloaded battery voltage Vᵤₙₗ of 1.1 V may correspond to a single cell battery that is almost entirely discharged. Because the battery 4 has a non-zero internal resistance, the input voltage V_{DDL} drops linearly as more current is drawn from the battery. It can be seen in FIG. 2 that the maximum output current I_{load} that the boost converter circuit 6 can deliver occurs when the input voltage V_{DDL} has dropped to half of the unloaded battery voltage Vᵤₙₗ (i.e. at V_{DDL}=0.55 V for Vᵤₙₗ=1.1 V).

The control circuit portion 20 is thus configured to monitor the input voltage V_{DDL} and control the switching arrangement 18 to prevent the input voltage V_{DDL} from dropping below a reference input voltage V_{REF,IN}, in order to maximise the output current. A period of normal operation of the boost converter circuit 6 (i.e. in the operational mode) will now be explained with addition reference to the timing diagram in FIG. 3.

Just prior to a first time t₁, the boost converter circuit 6 is providing the SoC 8 with an output voltage V_{DD} of 3 V. The SoC 8 is not demanding a particularly large amount of current (I_{load} is low) and the input voltage V_{DDL} is approximately equal to the unloaded voltage Vᵤₙₗ of 1.1 V.

At t₁, the current demand I_{load} of the SoC 8 suddenly increases (e.g. because a transmission cycle begins). At first, the boost converter circuit 6 simply reacts to stop V_{DD} from dropping significantly by providing the necessary increased current, using charge supplied by the battery decoupling capacitor 15. As the charge on the battery decoupling capacitor 15 is used up, the increased current demand on the battery causes V_{DDL} to drop (due to an increased voltage drop over the internal resistance).

At t₂, V_{DDL} drops below the reference input voltage, V_{REF,IN}. This causes the first comparator 28 to output a low signal to the control circuit portion 20. In response, the control circuit portion 20 stops boost converter operation and stops delivering current to the output of the boost converter circuit 6.

Whilst the boost converter operation is stopped, the current demand at the output is delivered by the first and second decoupling capacitors 12, 14, and the output voltage V_{DD} slowly falls as the decoupling capacitors 12, 14 are discharged.

After some time, when V_{DDL} has recovered to a voltage slightly higher than the V_{REF,IN} (to account for hysteresis of the first comparator 28), the first comparator 28 outputs a high signal to the control circuit portion 20 and boost converter operation starts again. This repeats whilst the current demand remains high, having the effect of stabilising the input voltage V_{DDL} at V_{REF,IN} and limiting the current output of the boost converter circuit 6.

The reference input voltage V_{REF,IN} is fixed at 0.75 V. FIG. 4 shows the maximum currents delivered by the boost converter circuit 6 for a variety of reference input voltages over a range of unloaded battery voltages Vᵤₙₗ. The theoretical optimal reference value to use is ½Vᵤₙₗ, but FIG. 4 shows that using a fixed reference value such 0.75 V can still produce good results over a wide range of unloaded battery voltages Vᵤₙₗ, whilst being simpler to implement than a reference value defined relative to the unloaded voltage. For instance, using a reference input voltage of 0.75 V allows the boost converter circuit 6 to deliver over 85% of the theoretical maximum current over the whole unloaded voltage range shown of 1.1 V to 1.6 V.

After the current limiting kicks in at t₂, the current demanded by the SoC 8 is higher than the maximum output current of the boost converter circuit 6. Thus, the output voltage V_{DD} begins to drop as charge is used up from the decoupling capacitors 28, 30. This drop continues until t₃, when the current demand of the SoC 8 drops back to its initial low value. However, the decoupling capacitors 28, 30 (and the battery decoupling capacitor 15) still need to be recharged back up to 3 V. The decoupling capacitors 28, 30 thus continue to draw a large output current from the boost converter circuit 6 (which continues to limit the output current by switching on and off based on the level of V_{DDL}) until they are fully recharged at time t₄. The current demanded from the boost converter circuit 6 then returns to a low level and the battery decoupling capacitor 15 re-charges to 1.1 V.

Thus, by monitoring the input voltage V_{DDL} and controlling the switching arrangement 18 in response, the boost converter circuit 6 can reliably output a maximum possible current.

A start-up mode of the circuit portion 2, in which the circuit portion 2 transitions from the sleep mode to the operational mode will now be described with additional reference to FIG. 5.

Prior to a time t₁ (unrelated to the first time discussed above), the circuit portion 2 is in a sleep mode. The SoC 8 is inactive and unpowered. The boost converter circuit 6 is switched off and the output voltage V_{DD} is terminated to ground (0 V) to avoid leakage currents. The first and second decoupling capacitors 12, 14 do not perform any decoupling. However, to reduce the start-up time of the circuit portion 2, during the sleep mode the second (larger) decoupling capacitor 14 is disconnected from V_{DD} by opening switches S3 and S4 and is connected directly to the input voltage V_{DDL} via switch S2. This speeds up start-up because the large second decoupling capacitor 14 only has to be charged from the input voltage V_{DDL} to the output voltage V_{VDD} to be operational, rather than having to be charged all the way from 0 V to the output voltage V_{DD}. The leakage through the larger second decoupling capacitor 14 is small, so little energy is lost through this connection.

At t₁, the hibernator circuit 9 receives a wake command to trigger the circuit portion 2 to enter the start-up mode to transition from the sleep mode into the operational mode. The hibernator circuit 9 sends a high signal on the ENABLE output 11 to the control circuit portion 20. At the same time, switch S1 is closed, connecting the output of the boost converter circuit 6 and the first decoupling capacitor 12 directly to the input voltage V_{DDL} from the battery 4. The output voltage V_{DD} at the output of the boost converter circuit 6 immediately starts to climb towards V_{DDL} (from 0 V).

At time t₂, the first decoupling capacitor 12 has been charged to V_{DDL}, and switch S1 is opened. The boost converter circuit 6 begins boost switching operation and the output voltage V_{DD} starts to raise further towards the target operational voltage of 3 V. The boost converter circuit 6 acts to limit the output current to prevent the input voltage V_{DDL} dropping below V_{REF,IN}, as explained above. At time t₃ (roughly 1 ms after the wake command), V_{DD} passes 1.8 V, which is sufficient for starting the SoC 8. The SoC 8 starts up and begins to operate. At this point only the first (smaller) decoupling capacitor 12 is fully operational so the SoC 8 may only perform low-power tasks.

At time t₄, V_{DD} reaches its normal operational level of 3 V. At t₅, after a short period to allow the battery decoupling capacitor 15 to recharge to 1.1 V, switch S2 is opened to disconnect the second decoupling capacitor 14 from V_{DDL}, and switch S3 is closed to connect the second decoupling capacitor 14 to the output voltage V_{DD} so that it begins charging to 3 V. The switch S3 connects the second decoupling capacitor 14 to the output voltage V_{DD} via a current limiting resistor 32 so as to limit the charging current sent to the second decoupling capacitor 14 and avoid dragging V_{DD} below the minimum operational voltage of 1.8 V. The current drawn by this charging process is initially greater than the maximum deliverable by the boost converter circuit 6 so the output voltage V_{DDL} does drop slightly. However after a short time the charging current drops (because the voltage on the second decoupling capacitor V_{DEC} has increased) and the output voltage recovers to 3 V.

At time t₆, the second decoupling capacitor 14 is sufficiently near the output voltage V_{DD}, and switch S4 is closed to connect the second decoupling capacitor 14 directly to V_{DD} (i.e. shorting the current limiting resistor 32). The second decoupling capacitor 14 is now able to provide additional decoupling to the SoC 8 and the circuit portion 2 enters the fully operational mode. At a later time t₇ the circuit portion 2 re-enters the sleep mode. The boost converter circuit 6 is turned off, V_{DD} is connected to ground and the second decoupling capacitor 14 is connected to V_{DDL}.

Thus, by splitting the decoupling capability of the circuit portion 2 into the first and second decoupling capacitors 12, 14, the start-up time for the boost converter circuit 6 (and thus for the SoC 8) is improved without sacrificing eventual decoupling capacity. The small first decoupling capacitor 12 can be charged quickly to provide initial decoupling for the SoC 8 and the larger second decoupling capacitor 14 is charged at a limited rate so as not to prevent SoC 8 operation.

However, the use of the current limiting resistor 32 to limit this charging current may not be optimal in all scenarios. For instance, the resistance of the current limiting resistor 32 is fixed which means that the magnitude of the charging current (and thus the rate of charging) decreases as the second decoupling capacitor 14 approaches the output voltage V_{DD}. Furthermore, this resistance must be selected conservatively to ensure that the charging current is sufficiently limited for a variety of possible operating conditions (e.g. different internal resistances of the battery 4). An alternative approach will now be described with reference to FIGS. 6 and 7.

FIG. 6 shows a circuit portion 102 in accordance with another embodiment of the invention. The circuit portion 102 is largely the same as the circuit portion 2 described above and shown in FIG. 1, but features a boost converter circuit 106 with an alternative decoupling capacitor charging portion 122 for charging the first and second decoupling capacitors 12, 14. The decoupling capacitor charging portion 122 comprises an AND gate 124 that takes the output of the second comparator 30 as a first input and a charging enable signal EN_S3 as a second input. When the output of the AND gate 124 is low, switch S3 is open (non-conducting), and vice versa.

Normal operation of this circuit portion 102 is the same as that of the circuit portion 2 described above. Start-up mode operation will now be described with additional reference to FIG. 7.

Start-up operation of the circuit portion 102 is the same as that of the circuit portion 2 described above with reference to FIG. 5 up until t₅ (i.e. the start of charging the second decoupling capacitor 14). The timing diagram FIG. 7 starts at t₄.

Initially, at t₄, the divided version of V_{DD} (V_{DD}/α) is just above the reference output voltage V_{REF,OUT} (i.e. V_{DD}>α×V_{REF,OUT}) and the output of the second comparator 30 is low. However, the charging enable signal EN_S3 is low, and the output of the AND gate 124 is thus low and the switch S3 is open.

At t₈, switch S2 is opened to disconnect the second decoupling capacitor 14 from V_{DDL}, and the charging enable signal EN_S3 is asserted. Both inputs to the AND gate 124 are now high (the output of the second comparator 30 is inverted at the input to the AND gate 124) and the output of the AND gate 124 is thus high and the switch S3 is closed.

This connects the second decoupling capacitor 14 directly to V_{DD} and the decoupling capacitor voltage V_{DEC} starts to climb towards the output voltage V_{DD}. Charge is transferred from the first decoupling capacitor 12 to the second decoupling capacitor 14, causing the output voltage V_{DD} to drop.

After a short charging pulse, at t₉, the divided version of V_{DD} (V_{DD}/α) has fallen a little below the reference output voltage V_{REF,OUT} (i.e. V_{DD}<αV_{REF,OUT}), overcoming the hysteresis of the second comparator 30. The output of the second comparator 30 goes high. The output of the AND gate 124 thus goes low and switch S3 opens. Charging of the second decoupling capacitor 14 pauses, and the output voltage V_{DD} begins to recover back to the target voltage of 3 V.

At t₁₀, the output voltage V_{DD} has recovered to 3 V (α×V_{REF,OUT}), triggering another charging pulse. These charging pulses repeat, gradually increasing the decoupling capacitor voltage V_{DEC} until t₁₁, at which point the decoupling capacitor voltage V_{DEC} is sufficiently close to 3 V. Signal EN_S3 goes low, and switch S4 is closed to connect the second decoupling capacitor 14 directly to V_{DD} to complete the charging of the second decoupling capacitor 14. The circuit portion 102 now enters the fully operational mode with decoupling of the SoC 8 provided by both the first and second decoupling capacitors 12, 14.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A boost converter circuit comprising:
an input arranged to receive an input voltage;
an output arranged to generate a higher, output voltage for powering a further circuit portion;
a switching arrangement arranged to control generation of the output voltage; and
a control circuit portion arranged to monitor the input voltage and control the switching arrangement in response to the input voltage.

2. The boost converter circuit as claimed in claim 1, wherein the control circuit portion is arranged to control the switching arrangement to limit an output current of the boost converter circuit in response to the input voltage.

3. The boost converter circuit as claimed in claim 2, wherein the control circuit portion comprises a comparator arranged to compare the input voltage with a reference input voltage and to control the switching arrangement to limit the output current of the boost converter circuit in response to an output of said comparator.

4. The boost converter circuit as claimed in claim 3, wherein the reference input voltage is between 25% and 75% of an unloaded power supply voltage.

5. The boost converter circuit as claimed in claim 3, wherein the reference input voltage is a predetermined reference input voltage.

6. The boost converter circuit as claimed in claim 5, wherein the predetermined reference input voltage is between 0.1 V and 2 V.

7.-9. (canceled)

10. A circuit portion comprising:
a power source arranged to generate an input voltage;
a boost converter circuit comprising an input arranged to receive the input voltage and an output arranged to generate a higher, output voltage for powering a further circuit portion; and
a decoupling capacitor;
wherein the circuit portion is configured to operate in:
a first mode in which the decoupling capacitor is connected to the power source; and
a second mode in which the decoupling capacitor is connected to the output of the boost converter circuit so as to provide decoupling to the further circuit portion.

11. The circuit portion as claimed in claim 10, wherein the second mode is an operational mode.

12. The circuit portion as claimed in claim 10, wherein the first mode is a sleep mode.

13. A circuit portion comprising:
a boost converter circuit comprising an input arranged to receive an input voltage and an output arranged to generate a higher, output voltage for powering a further circuit portion;
a first decoupling capacitor; and
a second decoupling capacitor;
wherein the circuit portion is configured to operate in:
a start-up mode in which the first decoupling capacitor is connected to the output of the boost converter circuit so as to provide decoupling to the further circuit portion, and in which the second decoupling capacitor is charged towards the output voltage with a limited charging current; and
an operational mode in which the first and second decoupling capacitors are connected to the output of the boost converter circuit so as to provide decoupling to the further circuit portion.

14. The circuit portion as claimed in claim 13, wherein the second decoupling capacitor has a larger capacitance than the first decoupling capacitor.

15. The circuit portion as claimed in claim 14, wherein the second decoupling capacitor has a capacitance of at least two times a capacitance of the first decoupling capacitor.

16. The circuit portion as claimed in claim 13, comprising a current-limiter arranged to provide said limited charging current in the start-up mode.

17. The circuit portion as claimed in claim 13, comprising a pulse charging circuit portion arranged to monitor the output voltage and to charge the second decoupling capacitor in the start-up mode in response to the output voltage.

18. The circuit portion as claimed in claim 17, wherein the pulse charging circuit portion comprise a comparator arranged to compare the output voltage to a reference output voltage and to charge the second decoupling capacitor based on an output of said comparator.

19. The circuit portion as claimed in claim 13, comprising a battery arranged to generate the input voltage.

20. The circuit portion as claimed in claim 19, wherein the battery has a capacity of 100 mAh or less.

21. The circuit portion as claimed in claim 10, comprising a mode control circuit portion configured to control a mode in which the circuit portion operates.

22. The circuit portion as claimed in claim 10, arranged to power a System-on-Chip.

23. The circuit portion as claimed in claim 2, wherein control circuit portion is arranged to control the switching arrangement to limit the output current of the boost converter circuit based on a comparison between the input voltage and a reference input voltage derived from an unloaded power supply voltage.
